(19) United States
(12) Patent Application Publication
(10) Pub. No.: US 2026/0359445 A1
(43) Pub. Date: Nov. 12, 2026

(54) FILESYSTEM LOCAL PRIVILEGE ESCALATION VULNERABILITY DETECTOR FOR LINUX AND ANDROID APPLICATIONS

(71) Applicant: Palo Alto Networks, Inc., Santa Clara, CA (US)

(72) Inventors: Ruian Duan, Fremont, CA (US); Asher Davila Loranca, San Jose, CA (US)

(21) Appl. No.: 19/202,958

(22) Filed: May 8, 2025

(51) Int. Cl. G06F 21/57; G06F 21/62

(52) U.S. Cl. CPC G06F 21/577; G06F 21/6218; G06F 2221/034

(57) ABSTRACT

A plurality of filesystem operations in a Linux or Android system are monitored. It is determined whether a first filesystem operation of the plurality of filesystem operations is run as a high-privilege user. In response to determining that the first filesystem operation is run as the high-privilege user, it is determined whether any low-privilege user is included in an access control list associated with a file on which the first filesystem operation is going to operate. A corresponding name of the first filesystem operation and a corresponding name of the file is logged in a logfile based on whether any low-privilege user is included in the access control list associated with the file on which the first filesystem operation is going to operate.

### BACKGROUND OF THE INVENTION

The security landscape of file systems has been increasingly challenged by local privilege escalation vulnerabilities related to filesystem operations in Linux and Android applications. Linux and Android systems have shared filesystems in which user-based security boundaries are maintained through access control lists. High-privileged users (i.e., root and sudo users) can read or write the whole filesystem. Low-privileged users, meanwhile, can only read or write user-specific paths and global writable paths according to the access control lists.

Local privilege escalation vulnerabilities occur when a high-privilege process (i.e., one that can only run as root or as a sudo user) interacts with a file to which a low-privilege user (i.e., one that does not have sudo privileges) has read, write, or execute access. As such, these vulnerabilities introduce significant security risks by potentially allowing unauthorized access and manipulation of files and directories. This can lead to issues, such as data leakage, system compromise, and denial of service, all of which can disrupt normal operations.

### BRIEF DESCRIPTION OF THE DRAWINGS

Various embodiments of the invention are disclosed in the following detailed description and the accompanying drawings.

FIG. 1 is a block diagram illustrating a system for detecting filesystem local privilege escalation vulnerabilities in Linux and Android applications in accordance with some embodiments.

FIG. 2 is a flow diagram illustrating a process for detecting filesystem local privilege escalation vulnerabilities in Linux and Android applications in accordance with some embodiments.

FIG. 3 is a flow diagram illustrating a process for monitoring filesystem operations in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods for filesystem local privilege escalation vulnerability detection for Linux and Android applications are disclosed herein. One example of a local privilege escalation vulnerability in Linux and Android systems is the Apport time-of-check time-of-use (TOCTOU) vulnerability. Apport is a crash reporting system in the Ubuntu Linux operating system that runs a root user and monitors running processes while automatically collecting crash data and generating reports to help developers debug issues. In certain versions of Apport, the process would check file permissions before processing a crash report but would not immediately use the verified file. An attacker with low privileges could take advantage and manipulate the intended file between time of check and time of use by replacing the file or creating a symlink from the crash dump file to another file to which they would not normally have access. This could potentially lead to arbitrary file read or write operations with root privileges, allowing an attacker to overwrite critical system files, execute malicious code, or escalate privileges, ultimately compromising the security and stability of the system.

A second example of a local privilege escalation vulnerability in Linux and Android systems is also a TOCTOU vulnerability involving needrestart, a common utility in Linux systems which checks running processes to see if their dependencies have been updated, and if so, restarts the running processes using local environment variables. Like Apport, the needrestart utility operates with root privileges and older versions would check the running processes before restarting them, creating a similar vulnerability that an attacker could exploit by crafting local environment variables to gain root privileges between time of check and time of use. This manipulation could lead needrestart to run the attacker's code with elevated privileges, potentially resulting in unauthorized system modifications, data breaches, or complete system compromise.

The systems and methods disclosed herein detect and notify developers of such privileged filesystem local privilege escalation vulnerabilities, such as create, move, overwrite, delete, read, and execute. This enables developers to patch vulnerabilities before attackers exploit them and prevents unauthorized access or modifications of files. Detecting privileged file system operations includes determining the privilege level of filesystem operations and the files they operate on. High-privilege users are system users in Linux and Android (which is Linux-based) systems, respectively, and root users in both Linux and Android systems. Low-privilege users do not have root, sudo, or system access (ex., a third-party app in Android). A low-privilege user has limited permissions when compared to a high-privilege user. Users are assigned low privileges to reduce the risk of accidental or malicious changes to the system.

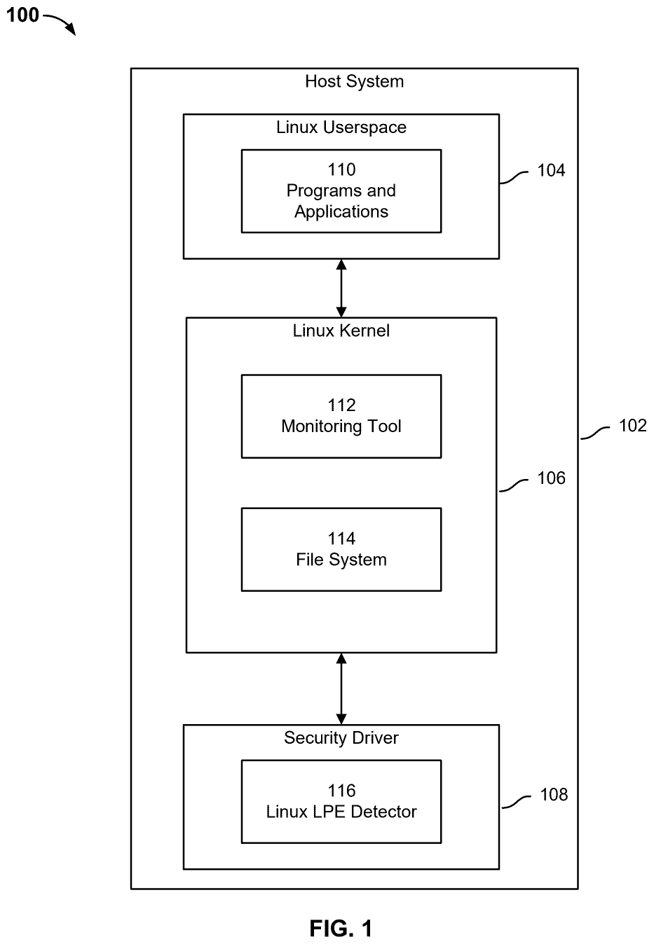

FIG. 1 is a block diagram illustrating a system for detecting filesystem local privilege escalation vulnerabilities in Linux and Android applications in accordance with some embodiments. In the example shown, system 100 includes host system 102. Host system 102 may be a laptop, a desktop, a server, a mobile device, etc. In some embodiments, host system 102 is capable of running the Linux or Android operating system.

Host system 102 includes Linux user space 104 and Linux kernel 106. Programs and applications 110 run as processes in Linux user space 104. Linux user space 104 is configured to interact with Linux kernel 106 through system calls.

Host system 102 further includes a security driver 108 (e.g., Cortex Extended Detection and Response (XDR)) configured to interact with Linux kernel 106. Security driver 106 includes a Linux local privilege escalation (LPE) detector 116. Linux LPE detector 116 is configured to monitor programs and applications 110 by monitoring system calls, API calls, and filesystem operations in Linux kernel using a monitoring tool 112 such as Extended Berkeley Packet Filter (eBPF). eBPF is a powerful, high-performance technology that allows users to safely run sandboxed programs in the Linux kernel, hooking the execution flow of system calls and kernel functions to understand and react to the behavior of the system in real-time.

Monitoring tool 112 monitors the interaction between running processes on Linux userspace 104 and Linux kernel 106 to capture data in real-time involving operations on file system 116. In some embodiments, Linux LPE detector 116 is run as a sudo user.

Monitored filesystem operations may include system and API calls for file creation (e.g., vfs_create, vfs_open, security_inode_create, vfs_mkdir, vfs_symlink, vfs_mknod), movement (e.g., vfs_rename), deletion (e.g., vfs_unlink, vfs_mdir), read (e.g., vfs_read), execution (e.g., mmap with PROT_EXEC), and non-existent (NX) path probing (e.g., explicit calls such as stat, lstat, statx, statfs, fstatfs, newstat, newlstat, fstata64, newfstat, newfstatat, or implicit calls with ENOENT such as open, openat, openat2, access, faccessat, faccessat2, creat, symlink, symlinkat, mkdir, mkdirat, unlink, unlinkat, rename, renameat, renameat2, rmdir).

By monitoring filesystem operations in real-time, Linux LPE detector 116 is a dynamic application security testing solution for detecting filesystem local privilege escalation vulnerabilities (i.e., instances when a high-privilege process running as root or a sudo user operates on files accessible by low-privilege users) in Linux and Android applications. Other systems focus on static analysis, identifying vulnerabilities by examining the source code or analyzing a decompiled version of the binary to detect potential issues without executing the program. Static analysis may generate false positives (i.e., report issues that aren't actually problems) and false negatives (i.e., miss real bugs entirely). This is because static analysis has limited context, since it analyzes the code without running it, so it doesn't see real inputs, execution paths, or system states.

Based on the access control list, Linux LPE detector 116 is configured to determine whether any of the files or folders associated with the processes running with elevated privileges can be operated on by a low-privilege user. Linux LPE detector 116 is configured to register this event into a log file.

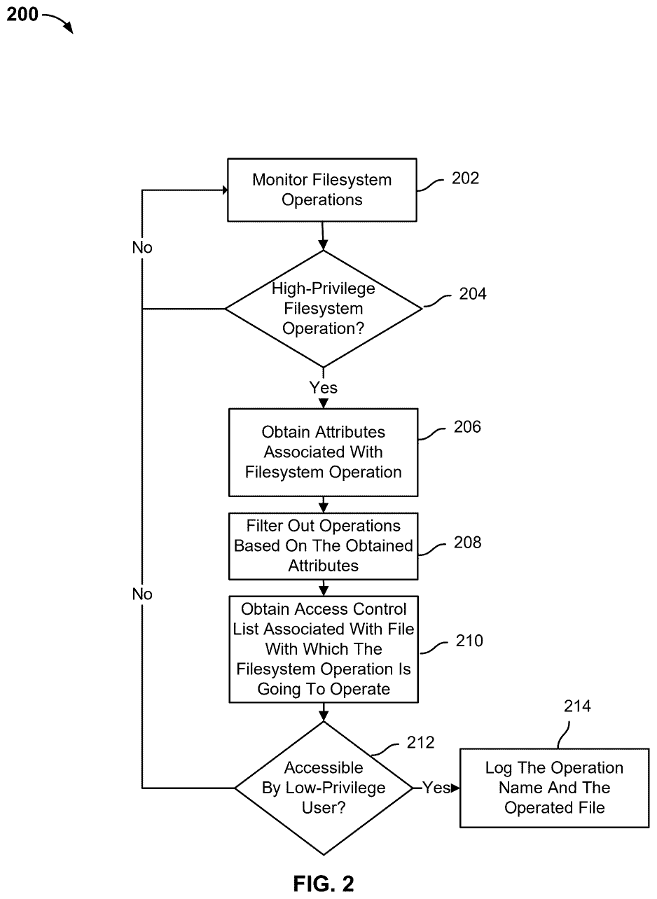

FIG. 2 is a flow diagram illustrating a process for detecting filesystem local privilege escalation vulnerabilities in Linux and Android applications in accordance with some embodiments. Process 200 may be performed by a Linux LPE detector, such as Linux LPE detector 116.

At 202, filesystem operations are monitored. Monitoring filesystem operations may include installing, running, updating, and/or uninstalling programs onto the system, using a monitoring tool, such as monitoring tool 112 to interact with filesystem operations, probing NX path operations, and/or creating NX paths.

In some embodiments, the monitoring tool is eBPF. In some embodiments, the monitoring tool is Berkeley Packet Filter Compiler Collection (BCC), which wraps eBPF interfaces using Python and can support C program generation for efficient filtering of eBPF events as well as Python-based interpretation and handling of corresponding events. BCC can be used to dynamically instrument filesystem operations for Linux and Android systems.

In some embodiments, filesystem operations are broken up into four modules for monitoring. In the sensitive creation, moving, and deletion (CMD) module, creation events are monitored by checking the invocation of file and directory creation-related functions such as vfs_create, vfs_open and security_inode_create, vfs_mkdir, vfs_symlink, and vfs_mknod; moving events are monitored by checking moving-related functions such as vfs_rename; deletion events are monitored by checking deletion-related functions such as vfs_unlink and vfs_rmdir.

In the sensitive read (R) module, read events are monitored by checking the invocation of read-related functions such as vfs_read.

In the sensitive execution (E) module, execution events are monitored by checking the invocation of execution-related functions, namely, mmap with execution bit set to true.

In the sensitive non-existent path (NX path) module, non-existent path probing events are monitored by by checking the invocation of functions that either explicitly check path existence or implicitly return non-existent-path error code (i.e. ENOENT). Explicit path existence check functions include stat-related functions (e.g. stat, lstat, statx, statfs, fstatfs, newstat, newlstat, fstatat64, newfstat, newfstatat). Implicit path existence check functions include open-related (e.g. open, openat, openat2), access-related (e.g. access, faccessat, faccessat2), create-related (e.g. creat, symlink, symlinkat, mkdir, mkdirat) and remove-related functions (e.g. unlink, unlinkat, rename, renameat, renameat2, rmdir).

In all four modules, an event is flagged as sensitive if the current process runs as high-privilege users (e.g., either root or sudo users) and the path being probed or its parent folders are writable by low-privilege users.

At 204, it is determined whether a filesystem operation is a high-privilege filesystem operation. In Linux and Android applications, a high-privilege filesystem operation is one that can only be run as root or as a sudo user. In response to determining that the filesystem operation is a high-privilege filesystem operation, process 200 proceeds to 206.

In response to determining that the filesystem operation is not a high-privilege filesystem operation, process 200 returns to 202. In some embodiments, in response to determining that the filesystem operation is a high-privilege filesystem operation, process 200 ends.

At 206, attributes associated with the filesystem operation associated with the current process are obtained. This may include metadata or contextual information about the filesystem operation either before, during, or after the filesystem operation associated with the current process is executed. Example attributes include the filesystem operation name, arguments, calling process, calling thread, return value, timing info, origin, and/or CPU state.

At 208, the current process is filtered based on the obtained filesystem operation attributes associated with the current process. For example, the Linux LPE detector may only be concerned with file overwrites. The Linux LPE detector may determine the one or more filesystem operations associated with the current process to determine whether the current process will perform a file overwrite. Processes that don't perform particular pre-defined actions may be ignored based on their filesystem operations.

The Linux LPE detector may return to step 202 to monitor filesystem operations associated with a subsequent process, if there are more processes to analyze. Otherwise, process 200 ends. In some embodiments, step 208 is optional.

At 210, an access control list associated with a file on which the process is going to operate is obtained. The access control list includes specific access rules for a plurality of users and groups.

At 212, it is determined whether any of the users in the access control list is a low-privilege user. In response to determining there is at least one low-privilege user included in the access control list associated with the file, process 200 proceeds to 214.

In response to determining there is not at least one security identifier from the set of security identifiers included in the access control list associated with the file, process 200 returns to 202. In some embodiments, in response to determining there is not at least one security identifier from the set of security identifiers included in the access control list associated with the file, process 200 ends.

At 214, the process name and the file on which the process operated is logged in a logfile. The Linux LPE detector may return to step 202 to monitor filesystem operations associated with a subsequent process, if there are more processes to analyze. Otherwise, process 200 ends.

In some embodiments, logging the process name and the file on which the process operated includes providing a report of sensitive logs to a user. Providing such a report to the user highlights sensitive filesystem operations and local privilege escalation vulnerabilities that could be exploited by an attacker in real-time on the Linux or Android system.

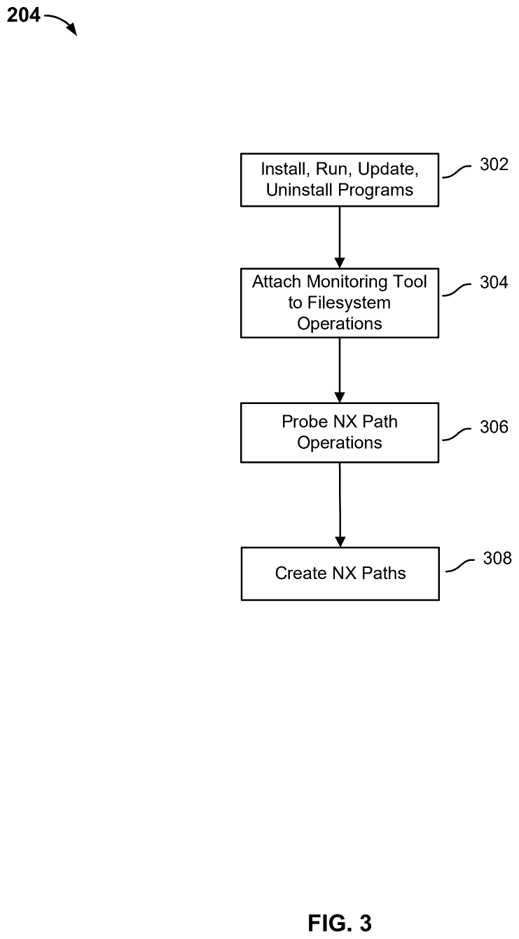

FIG. 3 is a flow diagram illustrating a process for monitoring filesystem operations in accordance with some embodiments. Process 300 may be performed by a Linux LPE detector, such as Linux LPE detector 116. Process 300 may be implemented to perform all or part of step 202 of process 200.

At 302, programs, such as programs and applications 110, are installed, run, updated, and/or uninstalled on the Linux or Android host system. In some embodiments, the programs are installed, run, updated, and/or uninstalled by a high-privilege user (e.g., root or a sudo user) in order to simulate a process that typically runs on Linux or Android with high-privilege. In some embodiments, the programs are installed, run, updated, and/or uninstalled by a low-privilege user (e.g., non-root user in Linux, or app user in Android) in order to simulate a process that typically runs on Linux or Android with low-privilege (e.g., developing an Android application as a local user).

The programs that are installed, run, updated, and/or uninstalled will have some sort of interaction with the file system, such as file system 114, on the Linux kernel.

At 304, a monitoring tool, such as monitoring tool 112 is attached to potentially sensitive filesystem operations.

Monitored filesystem operations may include system and API calls for file creation (e.g., vfs_create, vfs_open, security_inode_create, vfs_mkdir, vfs_symlink, vfs_mknod), movement (e.g., vfs_rename), deletion (e.g., vfs_unlink, vfs_mdir), read (e.g., vfs_read), execution (e.g., mmap with PROT_EXEC), and non-existent (NX) path probing (e.g., explicit calls such as stat, lstat, statx, statfs, fstatfs, newstat, newlstat, fstata64, newfstat, newfstatat, or implicit calls with ENOENT such as open, openat, openat2, access, faccessat, faccessat2, creat, symlink, symlinkat, mkdir, mkdirat, unlink, unlinkat, rename, renameat, renameat2, rmdir).

In some embodiments, the monitoring tool is eBPF. In some embodiments, monitoring the filesystem operations includes monitoring the filesystem operations across four modules: CMD, R, E, and NX path. In some embodiments, the Linux LPE detector and the monitoring tool are used in a continuous integration continuous deployment (CI/CD) pipeline and the CMD, R, E, and NP path modules are used to detect and collect sensitive events.

In some embodiments, the Linux LPE detector and the monitoring tool are used for runtime monitoring. In these cases, the four modules (CMD, R, E, and NX path) are run as daemons to passively collect sensitive CMD, R, E, and NX events.

The monitoring tool is configured to send a report of sensitive filesystem operations to the Linux LPE detector. The report may include all instances of sensitive event data collected from using the CMD, R, E, and NX path modules, including the name of the filesystem operation as well as the name of the path that is operated on.

At 306, NX path operations are probed. NX path operations are identified by detecting system or API calls (e.g., stat, statfs, open, etc.) made by the running programs that attempt to access files or directories which are not present at the time of access. Such operations are vulnerable because an attacker may detect that a file is not present at the time of access and create a symlink to a sensitive file or directory so that it exists the next time the path is probed by the operation. This manipulation could lead a program to run the attacker's code with elevated privileges, potentially resulting in unauthorized system modifications, data breaches, or complete system compromise.

At 308, the NX paths are created. In some embodiments, NX events are automatically used to create corresponding paths as low-privilege users. Creating the NX paths allows us to simulate attacker behavior and detect whether sensitive filesystem operations may be performed if the path exists and a file is executed in order to monitor potential vulnerabilities such as the one described above. In some embodiments, process 300 is repeated until no new NX events are observed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
monitoring a plurality of filesystem operations in a Linux or Android system;
determining whether a first filesystem operation of the plurality of filesystem operations is run as a high-privilege user;
in response to determining that the first filesystem operation is run as the high-privilege user, determining whether any low-privilege user is included in an access control list associated with a file on which the first filesystem operation is going to operate; and
logging in a logfile a corresponding name of the first filesystem operation and a corresponding name of the file based on whether any low-privilege user is included in the access control list associated with the file on which the first filesystem operation is going to operate.

2. The method of claim 1, further comprising determining whether a second filesystem operation of the plurality of filesystem operations is run as the high-privilege user in response to determining that the first filesystem operation is not run as the high-privilege user.

3. The method of claim 1, wherein high-privilege users include users with root or sudo privileges.

4. The method of claim 1, wherein low-privilege users include any users without root or sudo privileges.

5. The method of claim 1, wherein monitoring a plurality of filesystem operations in a Linux or Android system includes:
installing, running, updating, or uninstalling programs;
attaching a monitoring tool to the filesystem operations;
probing non-existent path operations; and
creating the previously non-existent paths.

6. The method of claim 5, wherein the programs are installed, run, updated, or uninstalled as a high-privilege user.

7. The method of claim 5, wherein the programs are installed, run, updated, or uninstalled as a low-privilege user.

8. The method of claim 1, wherein the filesystem operation is run as a high-privilege user.

9. The method of claim 1, further comprising obtaining attributes of one or more system calls or application programming interface (API) calls associated with the first filesystem operation.

10. The method of claim 9, wherein the attributes of the one or more system calls or API calls associated with the first filesystem operation include metadata or contextual information about the one or more system calls or API calls before, during, or after the one or more system calls or API calls associated with the current filesystem operation are executed.

11. The method of claim 9, further comprising filtering out the first filesystem operation based on the obtained attributes of the one or more system calls or API calls associated with the first filesystem operation.

12. The method of claim 9, further comprising obtaining the access control list associated with the file on which the first process is going to operate.

13. The method of claim 12, further comprising determining whether a second filesystem operation is run as a high-privilege user in response to determining that none of security identifiers included in the set of security identifiers is included in the access control list associated with the file on which the first filesystem operation is going to operate.

14. The method of claim 1, wherein a report is generated based on information included in the logfile.

15. The method of claim 14, wherein the information included in the logfile includes at least a filesystem operation name associated with the first filesystem operation and a filename associated with the file.

16. A system, comprising:
a processor configured to:
monitor a plurality of filesystem operations in a Linux or Android system;
determine whether a first filesystem operation is run as a high-privilege user;
in response to determining that the first filesystem operation is run as a high-privilege user, determine whether any low-privilege user is included in an access control list associated with a file on which the first filesystem operation is going to operate; and
log in a logfile a corresponding name of the first filesystem operation and a corresponding name of the file based on whether any low-privilege user is included in the access control list associated with the file on which the first filesystem operation is going to operate.

17. The system of claim 16, further comprising determine whether a second filesystem operation is run as a high-privilege user in response to determining that the first filesystem operation is not run as a high-privilege user.

18. The system of claim 16, further comprising define the set of security identifiers.

19. The system of claim 16, wherein monitoring a plurality of filesystem operations in a Linux or Android system includes:
installing, running, updating, or uninstalling programs;
attaching a monitoring tool to the filesystem operations;
probing non-existent path operations; and
creating the previously non-existent paths.

20. A computer program product embodied in a non-transitory computer readable medium and comprising computer instructions for:
monitoring a plurality of filesystem operations in a Linux or Android system;
determining whether a first filesystem operation is run as a high-privilege user;
in response to determining that the first filesystem operation is run as a high-privilege user, determining whether any low-privilege user is included in an access control list associated with a file on which the first filesystem operation is going to operate; and
logging in a logfile a corresponding name of the first filesystem operation and a corresponding name of the file based on whether any low-privilege user is included in the access control list associated with the file on which the first filesystem operation is going to operate.
